(19) United States
(12) Patent Application Publication
(10) Pub. No.: US 2017/0288200 A1
(43) Pub. Date: Oct. 5, 2017

(54) BATTERY CONNECTION SHEET AND METHOD FOR PREPARING THE SAME, BATTERY CONNECTION ASSEMBLY, BATTERY MODULE, BATTERY PACKAGE AND ELECTRIC VEHICLE

(71) Applicant: BYD COMPANY LIMITED, Shenzhen (CN)

(72) Inventors: QINGBO PENG, SHENZHEN (CN); WEIXIN ZHENG, SHENZHEN (CN); ZHIPEI LU, SHENZHEN (CN); YAN ZHU, SHENZHEN (CN); JIANHUA ZHU, SHENZHEN (CN)

(21) Appl. No.: 15/626,381

(22) Filed: Jun. 19, 2017

Related U.S. Application Data
(63) Continuation of application No. PCT/CN2015/098315, filed on Dec. 22, 2015.

(30) Foreign Application Priority Data
Dec. 23, 2014 (CN) 201410811637.9

(51) Int. Cl. H01M 2/20; B23K 20/06; B23K 20/233; H01R 31/06

(52) U.S. Cl. CPC H01M 2/206; H01R 31/06; B23K 20/06; B23K 20/233; B23K 20/2336; H01M 2220/20; B23K 2201/36

(57) ABSTRACT

The present disclosure discloses a battery connection sheet, including: a first part, including a first metal sheet, a first buffer portion and a first connection portion, and a second part, including a second metal sheet connected with the first connection portion via electromagnetic pulse welding.

### CROSS-REFERENCE TO RELATED APPLICATION

This application is a continuation application of International Application No. PCT/CN2015/098315, filed on Dec. 22, 2015, which is based on and claims priority to and benefits of Chinese Patent Application No. 201410811637.9, filed with the State Intellectual Property Office (SIPO) of the People's Republic of China on Dec. 23, 2014. The entire contents of the above-identified applications are incorporated herein by reference.

### FIELD

The present disclosure relates to a battery field, particularly refers to a battery connection sheet, a method preparing the same, a battery connection assembly, a battery module, a battery package, and an electric vehicle.

### BACKGROUND

A battery module used in an electric vehicle includes a plurality of single cells which are assembled together, and these single cells are connected through a connection sheet.

The single cells are connected together through a hard connection in the prior art, i.e. the connection sheet is an integrally formed flat board, and the connection sheet is configured with a plurality of mounting holes to connect with different electrodes of the single cells, thus achieve the connection of a battery module. The hard connection is usually formed by stamping which is easy to carry out and of lower manufacturing cost. However there is no buffer part existed in the hard connection, while assembling the battery module, it may be difficult to assemble the single cells if there is a larger manufacturing tolerance.

Moreover, the battery module may be affected by an external vibration during actual use, in which the hard connection may bear an energy impact owing to the vibration. Once the energy impact is too large, the hard connection may be broken or the electrode may be damaged.

The single cells are also connected together through a flexible connection sheet in the prior art. There is a flexible connection part located at the middle of the flexible connection sheet, which is formed by hot pressing and welding at a portion of a plurality of aluminum foils. The flexible connection sheet may overcome some problems mentioned above to some extent, but the manufacturing cost of the hot pressing is too high for assembly of a large-capacity battery pack. In addition, the flexible connection sheet is usually of a welding structure formed by two metals, which shows a low welding strength owing to conventional welding methods.

Thus, in order to produce a large-capacity battery pack, a new battery connection sheet with a better connection strength and a lower manufacturing cost is needed.

### SUMMARY

The present disclosure aims to solve at least one of the above problems to some extent, for example, to improve the connection between the single cells and decrease the manufacturing cost.

Accordingly, a connection sheet and a method of preparing the same, a battery connection assembly, a battery module, a battery package and an electric vehicle are provided by the present disclosure.

A battery connection sheet according to embodiments of the present disclosure includes: a first part, including a first metal sheet, a first buffer portion and a first connection portion, and a second part, including a second metal sheet connected with the first connection portion via electromagnetic pulse welding.

In some embodiments, the first part is of an integral structure, and the first buffer portion is located between the first metal sheet and the first connection portion.

In some embodiments, the first buffer portion has a sinusoidal shape.

In some embodiments, the first buffer portion includes: a first end, connected to the first metal sheet, a second end, connected to the first connection portion, a first wave trough, close to the first end, and a first wave crest, located between the first wave trough and the second end.

In some embodiments, the first buffer portion has a thickness thereof decreasing gradually from the first end to the first wave trough.

In some embodiments, the first buffer portion has a thickness thereof decreasing gradually from the second end to the first wave crest.

In some embodiments, the first end, the second end, the first metal sheet and the first connection portion have a same thickness.

In some embodiments, the first wave trough has a thickness of about 25% to about 35% based on that of the first metal sheet.

In some embodiments, the first wave crest has a thickness of about 25% to about 35% based on that of the first metal sheet.

In some embodiments, the first buffer portion has a span of about 100% to about 400% based on a thickness of the first metal sheet.

In some embodiments, the first metal sheet has a thickness of about 1.5 mm to about 4 mm.

In some embodiments, the first connection portion includes a first sidestep at an end thereof with a first recess, the second metal sheet includes a second sidestep at an end thereof with a second recess, and the first sidestep and the second sidestep are engaged to each other.

In some embodiments, a depth of the first recess is the same as a thickness of the second sidestep.

In some embodiments, a depth of the second recess is the same as a thickness of the first sidestep.

In some embodiments, a surface of the first connection portion contacted to the second metal sheet has no transition layer thereon.

In some embodiments, a portion of the first connection portion contacted to the second metal sheet has a width of about 1 mm to about 20 mm.

In some embodiments, the portion of the first connection portion contacted to the second metal sheet has a width of about 10 mm to about 20 mm.

In some embodiments, a connection strength between the first connection portion and the second metal sheet of about 100 MPa to about 1000 MPa.

In some embodiments, the connection strength between the first connection portion and the second metal sheet is about 150 MPa to about 600 MPa.

In some embodiments, the first metal sheet is configured with at least one mounting hole.

In some embodiments, the second metal sheet is configured with at least one mounting hole.

A method for preparing a battery connection sheet according to embodiments of the present disclosure includes: providing a first part including a first metal sheet, a first buffer portion and a first connection portion, providing a second part having a second metal sheet, obtaining a connection between the second metal sheet and the first connection portion through electromagnetic pulse welding the first part or the second part to.

In some embodiments, the method further includes: providing a first sidestep at an end of the first connection portion with a first recess, and providing a second sidestep at an end of the second metal sheet with a second recess; in which the electromagnetic pulse welding is performed at the first sidestep or the second sidestep.

In some embodiments, the first sidestep and the second sidestep are placed in parallel to and spaced apart from each other with a spacing of about 0.5 mm to about 4 mm.

In some embodiments, the first buffer portion is formed by stretching to obtain a sinusoidal shape.

In some embodiments, the first buffer portion is further formed by annealing after stretching to ensure a Vickers hardness of about 19 to about 25.

In some embodiments, the electromagnetic pulse welding is performed under a welding energy of about 16 KJ to about 96 KJ.

In some embodiments, the first part and the second part are made of different metals.

In some embodiments, the first metal sheet, the first buffer portion and the first connection portion are made of a same metal.

In some embodiments, each of the first metal sheet, the first buffer portion, the first connection portion and the second metal sheet is made of at least one material selected from a group consisting of copper, copper alloy, aluminum, and aluminum alloy respectively.

In some embodiments, the method further includes: molding at least one mounting hole at the first metal sheet, and molding at least one mounting hole at the second metal sheet.

A battery connection sheet obtained by a method according to embodiments of the present disclosure is also provided.

A battery connection assembly according to embodiments of the present disclosure includes: a plurality of connection bodies, and a plurality of connection metal sheets, configured to connect the plurality of connection bodies, each including: two second connection portions at two ends thereof respectively, and a second buffer portions between the two second connection portions; in which the connection body is a battery connection sheet mentioned above, and the connection body is contacted with the second connection portion of the connection metal sheet via electromagnetic pulse welding.

In some embodiments, the second buffer portion has a sinusoidal shape.

In some embodiments, the second buffer portion includes a second wave trough and a second wave crest, and the second buffer portion has a thickness decreasing gradually from one end to the second wave trough, and decreasing gradually from another end to the second wave crest.

A battery module according to embodiments of the present disclosure includes: a plurality of single cells and a plurality of battery connection sheets or battery connection assembly to connect the plurality of single cells; in which the battery connection sheet is a battery connection sheet mentioned above, the battery connection assembly is a battery connection assembly mentioned above.

The battery package according to embodiments of the present disclosure includes a plurality of battery modules, in which the battery module is a battery module mentioned above.

The electric vehicle according to embodiments of the present disclosure includes a plurality of battery packages, in which the battery package is a battery package mentioned above.

According to embodiments of the present disclosure, a battery connection sheet used to achieve stable connections with electrodes of a power battery module is provided. The battery connection sheet includes a first buffer portion which may provide a high ductility to the connection sheet, thus may remove the affection of an assembly tolerance during the assembly of the battery module, and may overcome the energy impact caused by vibration during actual use.

Meanwhile, the buffer portion may be manufactured by conventional stamping process, which may save the manufacturing cost of the battery connection sheet.

In the battery connection sheet according to the present disclosure, by providing a structure in which the second metal sheet is connected with the first connection portion via electromagnetic pulse welding, which may not form a brittle alloy structure, the battery connection sheet may show a better connection strength. And, the first connection portion and the second metal sheet may be made of different metals, in other word, a connection between different metals may be achieved, thus make the connection with the battery electrodes more easier and reliable. In addition, the battery connection assembly according to the present disclosure may assemble a plurality of battery connection sheets and a plurality of connection metal sheets, thus may connect a plurality of single cells in series and/or parallel, and avoid that the series and parallel of the single cells must be separated in the existing manufacturing process, finally improve the process efficiency.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the accompanying drawings, in which:

FIG. 1 is a schematic view of a battery connection sheet according to an embodiment of the present disclosure;

FIG. 2 is a front view of a battery connection sheet according to an embodiment of the present disclosure;

FIG. 3 is a schematic view of a battery connection assembly according to an embodiment of the present disclosure:

FIG. 4a is a schematic view of a battery module including a battery connection assembly according to the present disclosure:

FIG. 4b is a partially enlarged view of FIG. 4a;

FIG. 5 is an image of a flexible connection sheet according to a prior art:

FIG. 6 is a metallography image of a connection formed by electromagnetic pulse welding according to an embodiment of the present disclosure;

FIG. 7 is a metallography image of a connection formed by laser welding; and

FIG. 8 is a metallography image of a broken connection formed by laser welding.

### REFERENCE NUMERALS

first metal sheet 1, second metal sheet 2, first buffer portion 3, welding seam 4, connection metal sheet 5, battery connection sheet 6, first connection portion 7 and second connection portion 8.

### DETAILED DESCRIPTION

Reference will be made in detail to embodiments of the present disclosure, where the same or similar elements and the elements having the same or similar functions are denoted by like reference numerals throughout the descriptions. The embodiments described herein with reference to drawings are explanatory, illustrative, and used to generally understand the present disclosure. The embodiments shall not be construed to limit the present disclosure.

In the specification, it is to be understood that terms such as “length,” “width,” “thickness,” “upper,” “lower,” “front,” “rear.” “left,” “right,” “vertical,” “horizontal,” “top,” “bottom,” “inner,” and “outer” should be construed to refer to the orientation as then described or as shown in the drawings under discussion. These relative terms are for convenience of description and do not require that the present disclosure be constructed or operated in a particular orientation, thus shall not be construed to limit the present disclosure. In addition, terms such as “first” and “second” are used herein for purposes of description and are not intended to indicate or imply relative importance or significance or to imply the number of indicated technical features. Thus, the feature defined with “first” and “second” may include one or more of this feature. In the description of the present disclosure, “a plurality of” means at least two, e.g. two, three and so on, unless specified otherwise.

In the description of the present disclosure, it should be understood that, unless specified or limited otherwise, the terms “mounted,” “supported,” “connected,” and “coupled” and variations thereof are used broadly and encompass such as mechanical or electrical mountings, connections and couplings, also can be inner mountings, connections and couplings of two components, and further can be direct and indirect mountings, connections, and couplings, which can be understood by those skilled in the art according to the detail embodiment of the present disclosure.

A battery connection sheet 6 according to embodiments of the present disclosure will be described with reference to drawings.

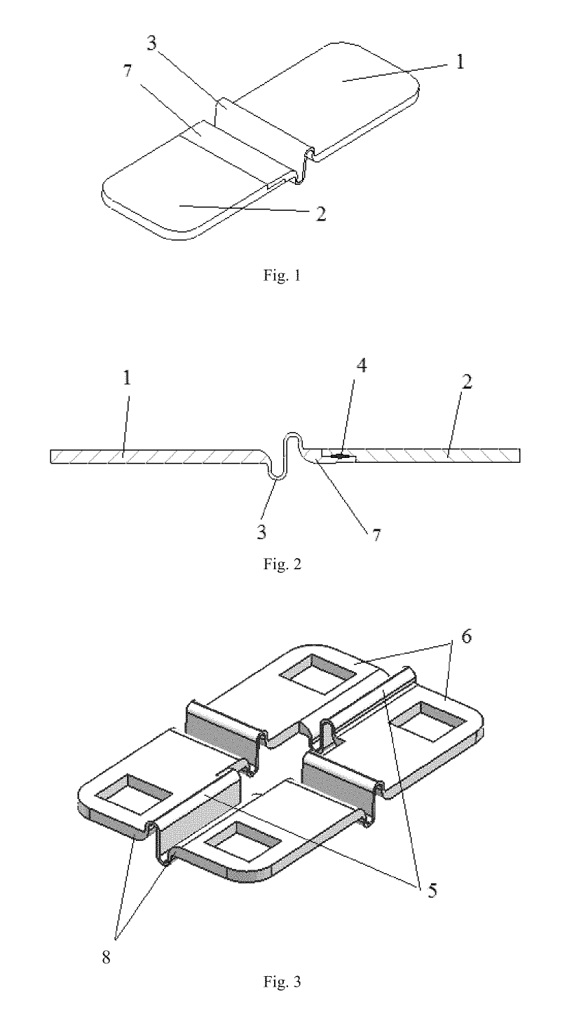

As shown in FIG. 1 or 2, the battery connection sheet 6 according to embodiments of the present disclosure includes: a first part, including a first metal sheet 1, a first buffer portion 3 and a first connection portion 7, and a second part, including a second metal sheet 2 connected with the first connection portion 7 via electromagnetic pulse welding. According to the present disclosure, the size of the battery connection sheet 6 may be selected according to actual requirements.

In some embodiments, the first part is of an integral structure, and the first buffer portion 3 is located between the first metal sheet 1 and the first connection portion 7. In other words, the first metal sheet 1, the first buffer portion 3 and the first connection portion 7 are of an integral structure. In some embodiments, the first part may be manufactured from an integral metal board, one end of the integral metal board may be defined as the first metal sheet 1, and the other end of the integral metal board may be processed into the first connection portion 7, and the first buffer portion 3 may be configured between the first metal sheet 1 and the first connection portion 7.

In some embodiments, the first buffer portion 3 may be formed by stretching a part between the first metal sheet 1 and the first connection portion 7, thus the thickness of the first buffer portion 3 is smaller than the thickness of the first metal sheet 1, i.e. the first buffer portion 3 is thinner than the first metal sheet 1. The first buffer portion 3 is located close to the first connection portion 7.

In some embodiments, the first buffer portion has a sinusoidal shape.

According to the present disclosure, the first buffer portion 3 of a sinusoidal shape may provide a flexible connection to the battery connection sheet 6, which provides a better cushioning effect and can reduce the fracture of the battery connection sheet 6 during a long-term use of the battery module. The first buffer portion 3 may provide a high ductility to the battery connection sheet 6 during the assembly of the battery module, thus may overcome assembling problems related to engineering tolerance, and provide a cushioning effect when a relative displacement occurs between the single cells due to an external force during the use of the battery module. It may further eliminate a pulling force caused by insertion of electrodes of two single cells into mounting holes, which may avoid the occurrence of loose electrodes, and reduce the decrease of the connection strength of the battery connection sheet 6 due to external forces. In some embodiments, the first buffer portion 3 may be of a single layer structure, for example, the first buffer portion 3 may be processed from a metal board.

According to the present disclosure, the thickness of the first buffer 3 may be variable. As shown in FIG. 2, the first buffer portion 3 is of a sinusoidal shape, including a first end, connected to the first metal sheet 1, a second end, connected to the first connection portion 7, a first wave trough, close to the first end, and a first wave crest, located between the first wave trough and the second end. In some embodiments, the first buffer portion has a thickness thereof decreasing gradually from the first end to the first wave trough. In some embodiments, the first buffer portion has a thickness thereof decreasing gradually from the second end to the first wave crest.

In some embodiments, the first end, the second end, the first metal sheet 1 and the first connection portion 7 have a same thickness. In some embodiments, the wave trough has a thickness of about 25% to about 35% based on that of the first metal sheet 1. In some embodiments, the wave crest has a thickness of about 25% to about 35% based on that of the first metal sheet 1. Unless specified or limited otherwise, the thickness of the first buffer portion refers to the thickness of the wave trough or the thickness of the wave crest.

As mentioned above, the first end of the first buffer portion 3 is connected to the first metal sheet 1, the second end of the first buffer portion 3 is connected to the first connection portion 7. As shown in FIG. 2, the first end refers to a tangent point defined by an upper contour line of the first metal sheet 1 and an upper arc contour line of the first buffer portion 3. Similarly, as shown in FIG. 2, the second end refers to a tangent point defined by a lower contour line of the first connection portion 7 and a lower arc contour line of the first buffer portion 3. In some embodiments, the thickness of the first metal sheet 1 is equal to that of the first connection portion 7. In some embodiments, the first buffer portion 3 has a span of about 100% to about 400% based on a thickness of the first metal sheet 1. The span is a width of the sinusoidal shape. i.e. a width of a sine wave as shown in FIG. 2. As can be seen in FIG. 2, the span refers to a distance from the first end of the first buffer portion 3 to the second end of the first buffer portion 3.

According to the present disclosure, the thickness of the first metal sheet 1 may be selected according to actual requirements as long as the first metal sheet 1 can provide enough connection strength to connect with the battery module. In some embodiments, the first metal sheet has a thickness of about 1.5 mm to about 4 mm.

In some embodiments, the second metal sheet 2 may have a same thickness with the first metal sheet 1.

In some embodiments, the first connection portion 7 includes a first sidestep at an end thereof with a first recess, the second metal sheet 2 includes a second sidestep at an end thereof with a second recess, and the first sidestep and the second sidestep are engaged to each other.

In some embodiments, a depth of the first recess is the same as a thickness of the second sidestep. In some embodiments, a depth of the second recess is the same as a thickness of the first sidestep.

According to the present disclosure, the first connection portion 7 with the second metal sheet 2 may be pre-processed to form a mutual dislocation and engaging platform respectively before being connected with each other. Then both the platforms of the first connection portion 7 with the second metal sheet 2 may be welded together, which may ensure a good flatness of the battery connection sheet 6 as shown in FIG. 2 and a good appearance, because the welding seam 4 is not located at the surface of the battery connection sheet 6.

In some embodiments, the first part and the second part are made of different metals. In some embodiments, the first metal sheet 1, the first buffer portion 3 and the first connection portion 7 are made of a same metal. In some embodiments, the first metal sheet 1 and the second metal sheet 2 may be made of a same metal, or may be made of different metals. In some embodiments, the first metal sheet 1 and the second metal sheet 2 are made of different metals, thus a connection between different metals may be achieved, which is suitable for assembly requirements of the batter module.

In some embodiments, each of the first metal sheet 1, the first buffer portion 3, the first connection portion 7 may be made of at least one material selected from a group consisting of copper, copper alloy, aluminum, and aluminum alloy respectively, and the second metal sheet 2 may be also made of at least one material selected from a group consisting of copper, copper alloy, aluminum, and aluminum alloy, and the first metal sheet 1 is made of a metal different with that of the second metal sheet 2. In some embodiments, first metal sheet 1, the first buffer portion 3, the first connection portion 7 are all made of copper, while the second metal sheet 2 is made of aluminum. Alternatively, first metal sheet 1, the first buffer portion 3, the first connection portion 7 are all made of aluminum, while the second metal sheet 2 is made of copper. The battery connection sheet 6 according to the present disclosure provides a connection between two different metals, which is more suitable for the connection between the single cells.

According to the present disclosure, the second metal sheet 2 is connected with the first connection portion 7 in a non-molten welding method. In some embodiments, a surface of the first connection portion contacted to the second metal sheet has no transition layer. In the description of the present disclosure, unless specified or limited otherwise, the term “transition layer” refers to a structure formed by a molten welding method, particularly refers to a recrystallization structure after melting of two different metals which are configured to manufacture a cover and a shell of a battery respectively; or the term “transition layer” refers to a structure formed by a brazing method, particularly refers to a brazing layer formed between a cover and a shell of a battery by the method of brazing. The second metal sheet 2 and the first connection portion 7 may be not affected by a heat caused by conventional welding method, the metal seam may be also wider than conventional welding method, which may provide a enough connection strength to the battery connection sheet 6 and a higher connection strength between different metals. Through the welding method according the present disclosure, i.e. through the electromagnetic pulse welding, the second metal sheet is contacted with the first connection portion in an atomic connection manner.

According to the present disclosure, there is no special limiting to the length of the first connection portion 7, as long as it's available for electromagnetic pulse welding to connect with the second metal sheet 2. In some embodiments, the first connection portion is contacted to the second metal sheet with a width of about 1 mm to about 20 mm. In some embodiments, the first connection portion is contacted to the second metal sheet with a width of about 10 mm to about 20 mm.

In some embodiments, a connection strength between the first connection portion and the second metal sheet is about 100 MPa to about 1000 MPa. In some embodiments, the connection strength between the first connection portion and the second metal sheet is about 150 MPa to about 600 MPa.

In some embodiments, the first metal sheet 1 is configured with at least one mounting hole. In some embodiments, the second metal sheet 2 is configured with at least one mounting hole.

A method for preparing a cooling plate module according to embodiments of the present disclosure includes: providing a first part having a first metal sheet, a first buffer portion and a first connection portion, providing a second part having a second metal sheet, obtaining a connection between the second metal sheet and the first connection portion through electromagnetic pulse welding the first part or the second part.

In some embodiments, the method further includes: providing a first sidestep at an end of the first connection portion with a first recess, and providing a second sidestep at an end of the second metal sheet with a second recess; in which the electromagnetic pulse welding is performed at the first sidestep or the second sidestep. In some embodiments, the first sidestep and the second sidestep are placed in parallel to and spaced apart from each other with a spacing of about 0.5 mm to about 4 mm.

In some embodiments, the first buffer portion is formed by stretching to obtain a sinusoidal shape.

In some embodiments, the first buffer portion is further formed by annealing after stretching to ensure a Vickers hardness of about 19 to about 25. With annealing treatment, a better flexibility may be provided to the first buffer portion 3.

As mentioned above, the first part and the second part may be made of different metals. In some embodiments, the first metal sheet, the first buffer portion and the first connection portion may be made of a same metal, while the first metal sheet and the second metal sheet are made of different metals.

According to the method of the present disclosure, the method further includes: molding at least one mounting hole at the first metal sheet, and molding at least one mounting hole at the second metal sheet.

In some embodiments, the electromagnetic pulse welding is performed under a welding energy of about 16 KJ to about 96 KJ.

A battery connection sheet obtained by a method according to embodiments of the present disclosure is also provided.

The battery connection assembly according to embodiments of the present disclosure includes: a plurality of connection bodies, and a plurality of connection metal sheets, configured to connect the plurality of connection bodies, each including: two second connection portions at two ends thereof respectively, and a second buffer portion between the two second connection portions; in which the connection body is a battery connection sheet mentioned above, and the connection body is contacted with the second connection portion of the connection metal sheet via electromagnetic pulse welding.

In some embodiments, the second buffer portion has a sinusoidal shape.

In some embodiments, the second buffer portion includes a second wave trough and a second wave crest, and the second buffer portion has a thickness decreasing gradually from one end to the second wave trough, and decreasing gradually from another end to the second wave crest.

In some embodiments, the second buffer portion may have a same shape with the first buffer portion mentioned above.

In some embodiments, the two second connection portions located at two ends of the connection metal sheet is connected to the first metal sheet and the second metal sheet respectively, and the connection manner is the same as the connection manner between the first connection portion and the second metal sheet, i.e. the atomic connection manner.

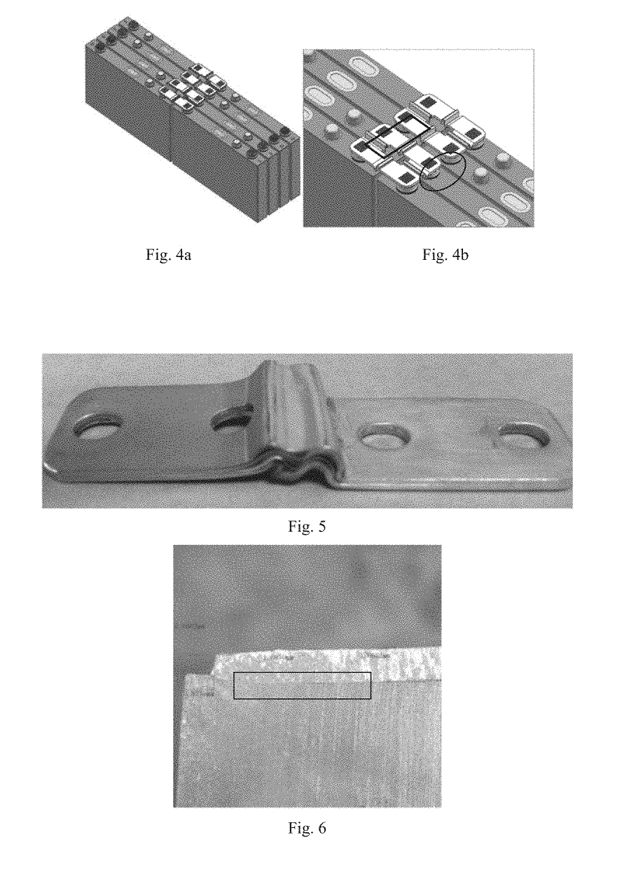

In some embodiments, the battery connection assembly may include at least two connection bodies. The battery connection assembly shown in FIGS. 3, 4a and 4b including only two connection bodies is illustrative, which shall not be construed to limit the present disclosure.

A battery module according to embodiments of the present disclosure includes: a plurality of single cells and a plurality of battery connection sheets or battery connection assembly to connect the plurality of single cells; in which the battery connection sheet is a battery connection sheet mentioned above, the battery connection assembly is a battery connection assembly mentioned above.

As shown in FIG. 4a and FIG. 4b, the fore-mentioned battery connection assembly may connect a plurality of single cells in series and/or parallel, which may improve the process efficiency.

In addition, as shown in FIGS. 3,4a and 4b, a battery connection assembly according to the present disclosure may connect 4 single cells. In one embodiment, two negative electrodes of two single cells are connected in parallel, which can be seen in a marked oval frame of FIG. 4b. Two positive electrodes of two single cells are connected in parallel, which can be seen in a marked rectangular frame of FIG. 4b. Meanwhile, the positive electrode marked in the rectangular frame is connected in series with the negative electrode marked in the oval frame. In other words, a battery connection assembly may connect four single cells both in parallel and in series, which may improve the process efficiency of the battery module. The number of the single cells connected by one battery connection assembly as shown in FIGS. 3, 4a and 4b is illustrative, which shall not be construed to limit the present disclosure.

The battery package according to embodiments of the present disclosure includes a plurality of battery modules, in which the battery module is a battery module mentioned above.

The electric vehicle according to embodiments of the present disclosure includes a plurality of battery packages, in which the battery package is a battery package mentioned above.

Hereinafter, the present disclosure will be described in details with reference to the following embodiments.

### Embodiment 1

The present embodiment provides a method for preparing a battery connection sheet, a battery connection assembly and a battery module. The method includes following steps.

(1) A first integral metal board was provided, and one end of the first integral metal board was processed into a first connection portion with a first sidestep, and the other end of the first integral metal board was processed into a first metal sheet, then a part between the first metal sheet and the first connection portion and close to the first connection portion was processed into a first buffer portion with a sinusoidal shape and was treated by annealing to have a Vickers hardness of 22. A second metal sheet was processed to be formed with a second sidestep on one end thereof, as shown in FIG. 2. Then the first sidestep and the second sidestep were placed in parallel and spaced apart from each other with a spacing of 2 mm. Electromagnetic pulse welding was carried out via a welding device PS48-16/25, purchased from PST Company, under a welding energy of 32 KJ. After surface smoothing treatment, a battery connection sheet was obtained, as shown in FIG. 1, in which the first connection portion was contacted to the second metal sheet with a width of 8 mm, i.e. the width of the welding seam between the first connection portion and the second metal sheet was 8 mm, the thickness of the first buffer portion was 0.6 mm, the span of the first buffer portion was 4 mm, the thicknesses of the first metal sheet and the second metal sheet both were 2 mm, the first metal sheet, the first buffer portion and the first connection portion were made of aluminum, and the second metal sheet was made of copper.

The welding seam between the first connection portion and the second metal sheet was tested with a metallurgical microscope, and the metallography image was shown in FIG. 6. As shown in FIG. 6, the first connection portion was contacted to the second metal sheet with no transition layer, i.e. there was no alloy or other composite formed between the first connection portion and the second metal sheet, which was shown in a marked rectangular frame of FIG. 6.

(2) Two of the battery connection sheets obtained by step (1) were placed in parallel as connection bodies. A second metal board was processed at the middle thereof to be formed with a sinusoidal shape and then was treated by annealing to have a Vickers hardness of 22, thus a second buffer portion was obtained. Then the two ends of the second metal board was processed into two second connection portions respectively, then a connection metal sheet was obtained.

Electromagnetic pulse welding was carried out via a welding device PS48-16/25, purchased from PST Company, under a welding energy of 32 KJ, to connect the two second connection portions of the connection metal sheet with the first metal sheet and the second metal sheet of the connection body. After a surface smoothing treatment, a battery connection assembly with a rectangular shape was obtained, as shown in FIG. 3, in which the second connection portion was contacted to the first/second metal sheet with a width of 8 mm, i.e. the width of the welding seam between the second connection portion and the first/second metal sheet was 8 mm, the second buffer portion and the second connection portions were made of aluminum. The thickness and the span of the second buffer portion was the same as that of the first buffer portion.

The welding seam between the second connection portion and the first/second metal sheet was tested with a metallurgical microscope, and the metallography image was shown in FIG. 6. As shown in FIG. 6, the second connection portion was contacted to the first/second metal sheet with no transition layer, i.e. there was no alloy or other composite formed between the second connection portion and the first/second metal sheet, which was shown in a marked rectangular frame of FIG. 6.

(3) All electrodes of four single cells were connected via the battery connection assembly obtained by step (2) as shown in FIGS. 4a and 4b, a battery module with a structure of connection both in parallel and series was obtained.

### Embodiment 2

The present embodiment provides a method for preparing a battery connection sheet, a battery connection assembly and a battery module. The method includes following steps.

(1) A first integral metal board was provided, and one end of the first integral metal board was processed into a first connection portion with a first sidestep, and the other end of the first integral metal board was processed into a first metal sheet, then a part between the first metal sheet and the first connection portion and close to the first connection portion was processed into a first buffer portion with a sinusoidal shape and was treated by annealing to have a Vickers hardness of 25. A second metal sheet was processed to be formed with a second sidestep on one end thereof, as shown in FIG. 2. Then the first sidestep and the second sidestep were placed in parallel and spaced apart from each other with a spacing of 1.5 mm. Electromagnetic pulse welding was carried out via a welding device PS48-16/25, purchased from PST Company, under a welding energy of 60 KJ. After surface smoothing treatment, a battery connection sheet was obtained, as shown in FIG. 1, in which the first connection portion was contacted to the second metal sheet with a width of 10 mm, i.e. the width of the welding seam between the first connection portion and the second metal sheet was 10 mm, the thickness of the first buffer portion was 1.4 mm, the span of the first buffer portion was 16 mm, the thicknesses of the first metal sheet and the second metal sheet both were 4 mm, the first metal sheet, the first buffer portion and the first connection portion were made of aluminum, and the second metal sheet was made of copper.

The welding seam between the first connection portion and the second metal sheet was tested with a metallurgical microscope, and the metallography image was shown in FIG. 6. As shown in FIG. 6, the first connection portion was contacted to the second metal sheet with no transition layer, i.e. there was no alloy or other composite formed between the first connection portion and the second metal sheet, which was shown in a marked rectangular frame of FIG. 6.

(2) Two of the battery connection sheets obtained by step (1) were placed in parallel as connection bodies. A second metal board was processed at the middle thereof to be formed with a sinusoidal shape and then was treated by annealing to have a Vickers hardness of 25, thus a second buffer portion was obtained. Then the two ends of the second metal board was processed into two second connection portions respectively, then a connection metal sheet was obtained. Electromagnetic pulse welding was carried out via a welding device PS48-16/25, purchased from PST Company, under a welding energy of 60 KJ, to connect the two second connection portions of the connection metal sheet with the first metal sheet and the second metal sheet of the connection body. After a surface smoothing treatment, a battery connection assembly with a rectangular shape was obtained, as shown in FIG. 3, in which the second connection portion was contacted to the first/second metal sheet with a width of 10 mm, i.e. the width of the welding seam between the second connection portion and the first/second metal sheet was 10 mm, the second buffer portion and the second connection portions were made of aluminum. The thickness and the span of the second buffer portion was the same as that of the first buffer portion.

The welding seam between the second connection portion and the first/second metal sheet was tested with a metallurgical microscope, and the metallography image was shown in FIG. 6. As shown in FIG. 6, the second connection portion was contacted to the first/second metal sheet with no transition layer, i.e. there was no alloy or other composite formed between the second connection portion and the first/second metal sheet, which was shown in a marked rectangular frame of FIG. 6.

(3) All electrodes of four single cells were connected via the battery connection assembly obtained by step (2) as shown in FIGS. 4a and 4b, a battery module with a structure of connection both in parallel and series was obtained.

### Embodiment 3

The present embodiment provides a method for preparing a battery connection sheet, a battery connection assembly and a battery module. The method includes following steps.

(1) A first integral metal board was provided, and one end of the first integral metal board was processed into a first connection portion with a first sidestep, and the other end of the first integral metal board was processed into a first metal sheet, then a part between the first metal sheet and the first connection portion and close to the first connection portion was processed into a first buffer portion with a sinusoidal shape and was treated by annealing to have a Vickers hardness of 19. A second metal sheet was processed to be formed with a second sidestep on one end thereof, as shown in FIG. 2. Then the first sidestep and the second sidestep were placed in parallel and spaced apart from each other with a spacing of 1.5 mm. Electromagnetic pulse welding was carried out via a welding device PS48-16/25, purchased from PST Company, under a welding energy of 16 KJ. After surface smoothing treatment, a battery connection sheet was obtained, as shown in FIG. 1, in which the first connection portion was contacted to the second metal sheet with a width of 15 mm, i.e. the width of the welding seam between the first connection portion and the second metal sheet was 15 mm, the thickness of the first buffer portion was 0.375 mm, the span of the first buffer portion was 1.5 mm, the thicknesses of the first metal sheet and the second metal sheet both were 1.5 mm, the first metal sheet, the first buffer portion and the first connection portion were made of aluminum, and the second metal sheet was made of copper.

The welding seam between the first connection portion and the second metal sheet was tested with a metallurgical microscope, and the metallography image was shown in FIG. 6. As shown in FIG. 6, the first connection portion was contacted to the second metal sheet with no transition layer, i.e. there was no alloy or other composite formed between the first connection portion and the second metal sheet, which was shown in a marked rectangular frame of FIG. 6.

(2) Two of the battery connection sheets obtained by step (1) were placed in parallel as connection bodies. A second metal board was processed at the middle thereof to be formed with a sinusoidal shape and then was treated by annealing to have a Vickers hardness of 19, thus a second buffer portion was obtained. Then the two ends of the second metal board was processed into two second connection portions respectively, then a connection metal sheet was obtained. Electromagnetic pulse welding was carried out via a welding device PS48-16/25, purchased from PST Company, under a welding energy of 16 KJ, to connect the two second connection portions of the connection metal sheet with the first metal sheet and the second metal sheet of the connection body. After a surface smoothing treatment, a battery connection assembly with a rectangular shape was obtained, as shown in FIG. 3, in which the second connection portion was contacted to the first/second metal sheet with a width of 15 mm, i.e. the width of the welding seam between the second connection portion and the first/second metal sheet was 15 mm, the second buffer portion and the second connection portions were made of aluminum. The thickness and the span of the second buffer portion was the same as that of the first buffer portion.

The welding seam between the second connection portion and the first/second metal sheet was tested with a metallurgical microscope, and the metallography image was shown in FIG. 6. As shown in FIG. 6, the second connection portion was contacted to the first/second metal sheet with no transition layer, i.e. there was no alloy or other composite formed between the second connection portion and the first/second metal sheet, which was shown in a marked rectangular frame of FIG. 6.

(3) All electrodes of four single cells were connected via the battery connection assembly obtained by step (2) as shown in FIGS. 4a and 4b, a battery module with a structure of connection both in parallel and series was obtained.

### Comparative Embodiment 1

As shown in FIG. 5, a plurality of aluminum foils were superposed together and were welded by laser welding via a welding device DISC8002, purchased from Trumpf Company, under a welding power of 3 KW. A flexible connection sheet was obtained, as shown in FIG. 5, in which the width of the welding seam was 1.5 mm.

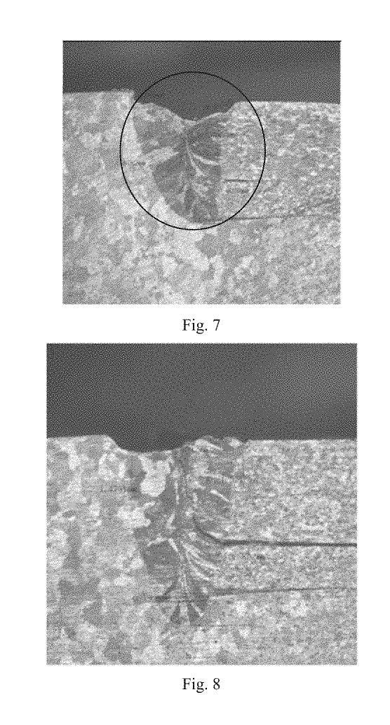

The welding seam was tested with a metallurgical microscope, and the metallography image was shown in FIG. 7. As shown in FIG. 7, the plurality of aluminum foils was connected together with a transition layer, i.e. there was a new alloy phase formed between the plurality of aluminum foils, or there was a transition layer formed between the plurality of aluminum foils, which was shown in a marked circular frame of FIG. 7.

After connection strength test, the welding seam between the plurality of aluminum foils was also tested with a metallurgical microscope, and the metallography image was shown in FIG. 8. As shown in FIG. 8, the connection formed by laser welding between the plurality of aluminum foils was broken, i.e. the transition layer was broken.

### Tests

(1) Connection Strength Test

The connection strength of the battery connection sheet samples and the battery connection assembly samples obtained above was measured by a tensile testing device GP-TS2000M purchased from Gopoint Technical Testing Company.

(2) Vickers Hardness Test

The Vickers hardness of the first buffer portion samples and the second buffer portion samples obtained above was tested by a Vickers hardness tester with a microscopic analysis.

(3) Random Vibration Test

The battery module samples obtained above was tested by a random vibration test according to IEC 60068-2-64, and the breaking time for the battery connection sheets were record. The results were shown in Table 1.

TABLE 1

| | Connection Strength | | Vickers Hardness | | Breaking |
|---|---|---|---|---|---|
| | 1* | 2 | 3* | 4* | Time |
| EMBODIMENT 1 | 200 MPa | 200 MPa | 22 | 22 | 96 h |
| EMBODIMENT 2 | 300 MPa | 300 MPa | 25 | 25 | 90 h |
| EMBODIMENT 3 | 450 MPa | 450 MPa | 19 | 19 | 92 h |
| COMPARATIVE | 50 MPa | | — | | 45 h |
| EMBODIMENT 1 | | | | | |

1* referred to the connection strength of the battery connection sheet, 2* referred to the connection strength of the battery connection assembly, 3* referred to the Vickers hardness of the first buffer portion, 4* referred to the Vickers hardness of the second buffer portion.

As can be seen from Table 1, in the battery connection sheet according to the present disclosure, a connection between different metals was achieved, and the connection strength was very high. The buffer portion (including the first buffer portion and the second buffer portion) provided a high ductility to the connection sheet/assembly, and removed the affection caused by external vibration.

As can be seen from Table 1, the breaking time for the battery module according to the present disclosure was twice of that of COMPARATIVE EMBODIMENT 1, i.e. the reliability of the battery module was significantly increased, and the a better flexibility of the connection sheet was also provided.

Reference throughout this specification to “one embodiment”, “some embodiments,” “an embodiment”, “a specific example,” or “some examples,” means that a particular feature, structure, material, or characteristic described in connection with the embodiment or example is included in at least one embodiment or example of the present disclosure. Thus, the appearances of the phrases in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated that the above embodiments are explanatory and cannot be construed to limit the present disclosure, and changes, alternatives, and modifications can be made in the embodiments without departing from scope of the present disclosure by those skilled in the art.

What is claimed is:

1. A battery connection sheet, comprising:
a first part, comprising a first metal sheet, a first buffer portion and a first connection portion, and
a second part, comprising a second metal sheet connected with the first connection portion via electromagnetic pulse welding.

2. The battery connection sheet according to claim 1, the first part is of an integral structure, and the first buffer portion is located between the first metal sheet and the first connection portion.

3. The battery connection sheet according to claim 1, wherein the first buffer portion has a sinusoidal shape.

4. The battery connection sheet according to claim 3, wherein the first buffer portion comprises:
a first end, connected to the first metal sheet,
a second end, connected to the first connection portion,
a first wave trough, close to the first end, and
a first wave crest, located between the first wave trough and the second end.

5. The battery connection sheet according to claim 4, wherein the first buffer portion has a thickness thereof decreasing gradually from the first end to the first wave trough, and decreasing gradually from the second end to the first wave crest.

6. The battery connection sheet according to claim 4, wherein the first end, the second end, the first metal sheet and the first connection portion have a same thickness.

7. The battery connection sheet according to claim 4, wherein the first wave trough has a thickness of about 25% to about 35% based on a thickness of the first metal sheet, the first wave crest has a thickness of about 25% to about 35% based on the thickness of the first metal sheet, and the first buffer portion has a span of about 100% to about 400% based on the thickness of the first metal sheet.

8. The battery connection sheet according to claim 1, wherein the first connection portion comprises a first sidestep at an end thereof with a first recess, the second metal sheet comprises a second sidestep at an end thereof with a second recess, and the first sidestep and the second sidestep are engaged to each other.

9. The battery connection sheet according to claim 8, wherein a depth of the first recess is the same as a thickness of the second sidestep, and a depth of the second recess is the same as a thickness of the first sidestep.

10. The battery connection sheet according to claim 1, wherein a surface of the first connection portion contacted to the second metal sheet has no transition layer thereon.

11. The battery connection sheet according to claim 1, wherein the first metal sheet is configured with at least one mounting hole, and the second metal sheet is configured with at least one mounting hole.

12. A method for preparing a battery connection sheet, comprising:
providing a first part having a first metal sheet, a first buffer portion and a first connection portion,
providing a second part having a second metal sheet,
obtaining a connection between the second metal sheet and the first connection portion through electromagnetic pulse welding the first part or the second part.

13. The method according to claim 12, further comprising
providing a first sidestep at an end of the first connection portion with a first recess, and
providing a second sidestep at an end of the second metal sheet with a second recess;
wherein the electromagnetic pulse welding is performed at the first sidestep or the second sidestep.

14. The method according to claim 12, wherein the first buffer portion is formed by stretching to obtain a sinusoidal shape.

15. The method according to claim 12, wherein the first part and the second part are made of different metals.

16. The method according to claim 12, wherein the first metal sheet, the first buffer portion and the first connection portion are made of a same metal.

17. The method according to claim 12, wherein each of the first metal sheet, the first buffer portion, the first connection portion and the second metal sheet is made of at least one material selected from a group consisting of copper, copper alloy, aluminum, and aluminum alloy respectively.

18. The method according to claim 12, further comprising:
molding at least one mounting hole at the first metal sheet, and
molding at least one mounting hole at the second metal sheet.

19. A battery connection assembly, comprising:
a plurality of connection bodies, and
a plurality of connection metal sheets, configured to connect the plurality of connection bodies, each comprising:
two second connection portions at two ends thereof respectively, and
a second buffer portion between the two second connection portions;
wherein the connection body comprises a first part which includes a first metal sheet, a first buffer portion and a first connection portion, and a second part which includes a second metal sheet connected with the first connection portion via electromagnetic pulse welding; and
the connection body is contacted with the second connection portion of the connection metal sheet via electromagnetic pulse welding.

20. The battery connection assembly according to claim 19, wherein the second buffer portion has a sinusoidal shape, the second buffer portion comprises a second wave trough and a second wave crest, and the second buffer portion has a thickness decreasing gradually from one end to the second wave trough, and decreasing gradually from another end to the second wave crest.
